(19) United States
(12) Patent Application Publication
(10) Pub. No.: US 2018/0314207 A1
(43) Pub. Date: Nov. 1, 2018

(54) HOLOGRAPHIC DISPLAY APPARATUS AND DISPLAY METHOD FOR THE SAME

(71) Applicant: BOE TECHNOLOGY GROUP CO., LTD., Beijing (CN)

(72) Inventors: Xin Gu, Beijing (CN); Xue Dong, Beijing (CN); Feng Guan, Beijing (CN); Jifeng Tan, Beijing (CN); Meili Wang, Beijing (CN); Wei Wang, Beijing (CN)

(21) Appl. No.: 15/744,756

(22) PCT Filed: Jul. 10, 2017
(86) PCT No.: PCT/CN2017/092378

§ 371 Date: Jan. 12, 2018

(30) Foreign Application Priority Data
Sep. 8, 2016 (CN) 201610811510.6

(51) Int. Cl. G03H 1/22; G02B 27/22

(52) U.S. Cl. CPC G03H 1/2286; G03H 2225/34; G03H 2222/20; G02B 27/22

(57) ABSTRACT

A holographic display apparatus and a display method thereof are disclosed. The holographic display apparatus includes: a backlight source configured to supply a coherent reference light; an optical switch configured to modulate light wave amplitude information of the coherent reference light; and a phase control plate configured to modulate light wave phase information of the coherent reference light, wherein the phase control plate and the optical switch are arranged on a light exit side of the backlight source.

### CROSS-REFERENCE TO RELATED APPLICATION

This application claims priority of the Chinese Patent Application No. 201610811510.6, filed with the State Intellectual Property Office of China on Sep. 8, 2016, which is incorporated herein by reference in its entirety.

### BACKGROUND OF THE DISCLOSURE

### Field of the Disclosure

The present disclosure relates to the technical field of three dimensional display, and in particular, to a holographic display apparatus and a display method for the holographic display apparatus.

### Description of the Related Art

Display technology can transmit information to people in visual form. It is very significant in the lives of people. It is estimated by scientists that 70% to 80% of information acquired by human beings derives from vision.

A three dimensional display is very significant in current society. The holographic display will be technology that has the largest possibility of achieving real three dimensional display. The holographic display may provide all of the information of object waves and have perfect depth and parallax, which may provide all of the physiological and psychological senses on the three dimensional display required by the human beings.

A method for recording and restoring object waves using interference and diffraction characteristics of optical waves is called holography. As phase information and amplitude information of the objects and images are recorded, the three dimensional images may be restored. A conventional holographic display system modulates both phase and amplitude of the light using an optical or electrical addressable space modulator and requires the space modulator to have a high refreshing rate, and rapid response speed, which is difficult to be satisfied. Therefore, some issues such as large crosstalk, low resolution, and/or visual fatigue may occur, which is adverse to achieve optimal three dimensional visual effects.

### SUMMARY

In view of this, an embodiment of the present disclosure provides a holographic display apparatus and a display method thereof, so as to at least partly alleviate poor effects of three dimensional vision of the conventional space modulator in the holographic display.

An embodiment of the present disclosure provides a holographic display apparatus, including: a backlight source configured to supply a coherent reference light; an optical switch configured to modulate light wave amplitude information of the coherent reference light; and a phase control plate configured to modulate light wave phase information of the coherent reference light, wherein the phase control plate and the optical switch are arranged on a light exit side of the backlight source.

In an embodiment, the phase control plate is arranged between the backlight source and the optical switch; or the phase control plate is arranged on a light exit side of the optical switch.

In an embodiment, the phase control plate includes a plurality of modulating regions independent from each other; the modulating regions are in one-to-one correspondence with the pixel regions in the optical switch, or one of the modulating regions corresponds to a plurality of pixel regions in the optical switch.

In an embodiment, two adjacent modulating regions modulate the coherent reference light at different phase modulation angles.

In an embodiment, all of the modulating regions modulate the coherent reference light at a constant phase modulation angle.

In an embodiment, all of the modulating regions modulate the coherent reference light at a phase modulation angle which is variable depending on received amplitude modulation signals.

In an embodiment, the phase control plate includes a grating phase control plate, an optical layer thickness phase control plate, or a liquid crystal phase control plate.

In an embodiment, the optical switch includes a liquid crystal display device, an electrochromic device or a photochromic device.

In an embodiment, the coherent reference light supplied by the backlight source is a coherent collimated light.

In another aspect, an embodiment of the present disclosure provides a display method for the above holographic display apparatus, the method including: supplying a coherent reference light by the backlight source; modulating light wave phase information of the coherent reference light by the phase control plate; modulating light wave amplitude information of the coherent reference light by the optical switch depending on a received modulation signal.

### BRIEF DESCRIPTION OF THE DRAWINGS

FIG. 1 is a first schematic view showing a structure of a holographic display apparatus provided by an embodiment of the present disclosure;

FIG. 2 is a second schematic view showing a structure of a holographic display apparatus provided by an embodiment of the present disclosure;

FIG. 3 is a schematic view showing a specific structure of a holographic display apparatus provided by an embodiment of the present disclosure;

FIG. 4 shows a schematic structure of a holographic display apparatus according to an embodiment of the present disclosure, in which each modulating region of a phase control plate corresponds to a plurality of pixel regions;

FIG. 5 shows a schematic structure of a holographic display apparatus according to an embodiment of the present disclosure, in which each modulating region of a phase control plate corresponds to one pixel region;

FIG. 6 shows an example of a phase control plate of a holographic display apparatus according to an embodiment of the present disclosure;

FIG. 7 shows another example of a phase control plate of a holographic display apparatus according to an embodiment of the present disclosure;

FIG. 8 shows a further example of a phase control plate of a holographic display apparatus according to an embodiment of the present disclosure; and

FIG. 9 is a flow chart of a display method for a holographic display apparatus according to an embodiment of the present disclosure.

### DETAILED DESCRIPTION OF PREFERRED EMBODIMENTS OF THE DISCLOSURE

The solutions of the holographic display apparatus and the display method of the same provided by exemplified embodiments of the present disclosure will below be explained in detail with reference to the accompanied drawings.

Shapes and sizes of various components in drawings do not reflect real scales of the holographic display apparatus, but are intended to explain the contents of the present disclosure.

In accordance with a generic concept of the present disclosure, an embodiment of the present disclosure provides a holographic display apparatus, including: a backlight source configured to supply a coherent reference light; an optical switch configured to modulate light wave amplitude information of the coherent reference light; and a phase control plate configured to modulate light wave phase information of the coherent reference light, wherein the phase control plate and the optical switch are arranged on a light exit side of the backlight source.

In addition, in the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

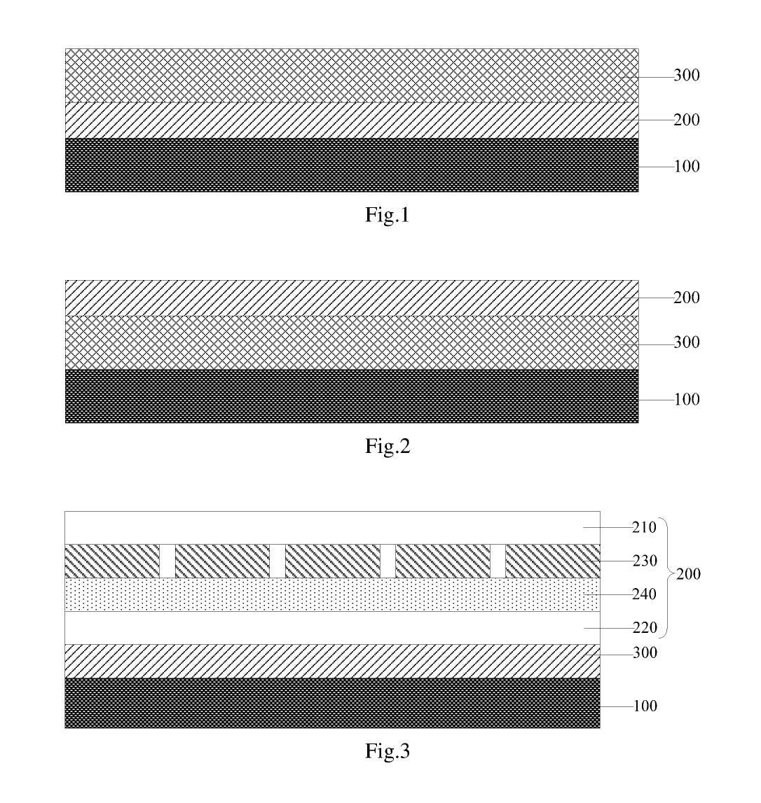

An embodiment of the present disclosure provides a holographic display apparatus. As shown in FIG. 1 and FIG. 2, the holographic display apparatus includes: a backlight source 100 configured to supply a coherent reference light; an optical switch 200 configured to modulate light wave amplitude information of the coherent reference light; and a phase control plate 300 configured to modulate light wave phase information of the coherent reference light, wherein the phase control plate 300 and the optical switch 200 are arranged on a light exit side of the backlight source 100.

Specifically, in the above holographic display apparatus provided by the embodiment of the present disclosure, the phase modulation and the amplitude modulation are arranged separately to achieve independent control of light wave phase information and light wave amplitude information, thus, use of the optical switch 200 to modulate the light wave amplitude information and use of the phase control plate 300 to modulate the light wave phase information may facilitate to improve capability of controlling the modulated objects to achieve holographic display with high quality. And the light wave phase information may be modulated by the phase control plate 300. It may achieve naked eyes' three dimensional display in multi-views.

In a practical example, in the above holographic display apparatus provided by the embodiment of the present disclosure, the phase control plate 300 and the optical switch 200 are both arranged on the light exit side of the backlight source 100, thus, in particular, as shown in FIG. 2, the phase control plate 300 maybe arranged between the backlight source 100 and the optical switch 200; or, as shown in FIG. 1, the phase control plate 300 may be arranged on a light exit side of optical switch 200, that is, the optical switch 200 is arranged between the backlight source 100 and the phase control plate 300. They are not intended to limit the embodiments of the present disclosure herein.

In particular, in the above holographic display apparatus provided by the embodiment of the present disclosure, the backlight source 100 for supplying a coherent reference light may in practice be implemented as an OLED backlight source or an LED backlight source, or the like, or implemented as a dynamic backlight source. They are not intended to limit the embodiments of the present disclosure herein. And as an example, in order to facilitate the coherent reference light to produce interference and diffraction, in the above holographic display apparatus provided by the embodiment of the present disclosure, the coherent reference light provided by the backlight source 100 is preferably a coherent collimated light, that is, the backlight source 100 is preferably a collimated backlight source.

In particular, in the above holographic display apparatus provided by the embodiment of the present disclosure, the optical switch 200 for modulating the light wave amplitude information of the coherent reference light may be implemented in various forms, for example, may be implemented as liquid crystal display device, an electrochromic device or a photochromic device. It may also be implemented as a device which modulates the light wave amplitude information depending on received modulation signals, such as micro-electromechanical system (MEMS).

In particular, in the above holographic display apparatus provided by the embodiment of the present disclosure, when the optical switch 200 is an electrochromic device, as shown in FIG. 3, the optical switch 200 in particular includes: an upper substrate 210 and a lower substrate 220 opposed to each other and an electrochromic material layer 230 arranged between the upper substrate 210 and the lower substrate 220. Further, it may include an electrolyte layer 240. And as shown in FIG. 3, the electrolyte layer 240 may be located on the side of the electrochromic material layer 230 close to the lower substrate 220, or may be located on the side of the electrochromic material layer 230 close to the upper substrate 210. They are not intended to limit the embodiments of the present disclosure herein.

In particular, in the above holographic display apparatus provided by the embodiment of the present disclosure, when the optical switch 200 is selected as another device such as a liquid crystal display device or a photochromic device, it has a structure similar to the electrochromic device. They are not intended to limit the embodiments of the present disclosure herein.

In a practical example, in order to achieve modulation of the light wave phase information, in the above holographic display apparatus provided by the embodiment of the present disclosure, the phase control plate 300 typically includes a plurality of modulating regions separated from each other; and the modulating regions may be in one-to-one correspondence with pixel regions in the optical switch 200, or one of the modulating regions may correspond to a plurality of pixel regions in the optical switch 200. They are not intended to limit the embodiments of the present disclosure herein.

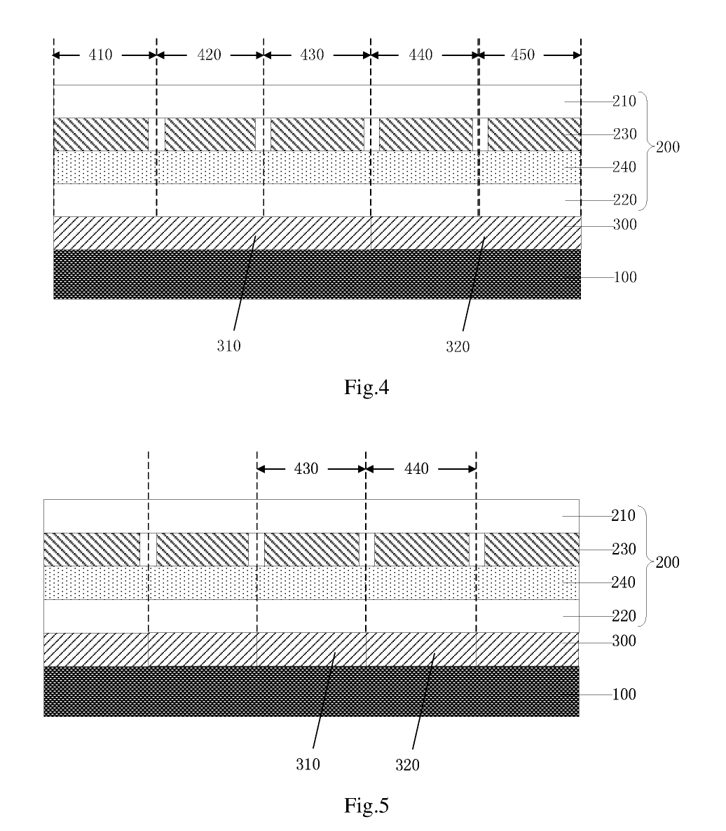

As an example, in the structure shown in FIG. 4, each of the modulating regions of the phase control plate 300 corresponds to the plurality of pixel regions in the optical switch 200. For example, the first modulating region 310 corresponds to three pixel regions 410, 420, 430, and the second modulating region 320 corresponds to two pixel regions 440, 450. In contrast, in the structure shown in FIG. 5, each of the modulating regions of the phase control plate 300 corresponds to one of pixel regions in the optical switch 200. For example, the first modulating region 310 corresponds to one pixel region 430, and the second modulating region 320 corresponds to one pixel region 440. The phrase of “modulating region corresponds to one region or a plurality of pixel regions” means that the modulating region is arranged to modulate phase of lights which exit from the one region or the plurality of pixel regions. As an example, one modulating region may be aligned with one or more pixel regions.

And, in the above holographic display apparatus provided by the embodiment of the present disclosure, two adjacent modulating regions in the phase control plate 300 typically modulate the coherent reference light at different phase modulation angles. And adjustability of the phase modulation angles typically is controlled in 0 to 2π, that is, the phase modulation angles are selected in a range between 0 and 2π.

In a practical example, in order to achieve dynamic display of holographic images, in the above holographic display apparatus provided by the embodiment of the present disclosure, the holographic display may in particular be achieved by three following modes: in the first mode, the modulated light wave amplitude information varies dynamically while the phase modulation angle of the modulated light wave phase information is constant relatively; in the second mode, the modulated light wave amplitude information varies dynamically and the phase modulation angle of the modulated light wave phase information also varies dynamically as a viewing angle changes; in the third mode, the modulated light wave amplitude information is constant relatively while the phase modulation angles of the light wave phase information are modulated, so as to achieve dynamical holographic display. In view of this, in the above holographic display apparatus provided by the embodiment of the present disclosure, all of the modulating regions in the phase control plate 300 may modulate the light at a constant phase modulation angle, or all of the modulating regions may modulate the light at phase modulation angles which is variable dynamically depending on received amplitude modulation signals (for example amplitude modulation signals).

In particular, in the above holographic display apparatus provided by the embodiment of the present disclosure, specific forms of the phase control plate 300 may be selected depending on whether respective modulating regions in the phase control plate 300 need to dynamically modulate phase modulation angles, for example, when all of the modulating regions in the phase control plate 300 modulate the light at the constant phase modulation angle, the phase control plate 300 may be selected as a grating phase control plate, an optical layer thickness phase control plate, or a liquid crystal phase control plate. When all of the modulating regions in the phase control plate 300 needs to modulate the light at phase modulation angles which are variable dynamically, the phase control plate 300 may be selected as a liquid crystal phase control plate.

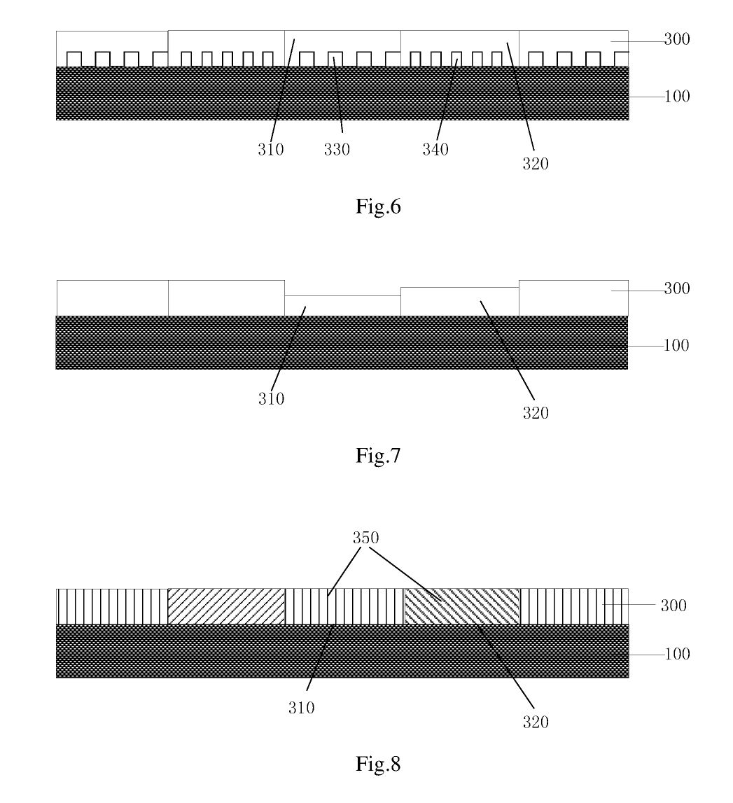

In an example, in particular, the grating phase control plate means that the respective modulating regions in the phase control plate 300 are provided with nanometer gratings having different grating periods therein to achieve varying degrees of phase angle modulation on the light wave phase information of the light passing through the gratings. In the example of the phase control plate 300 shown in FIG. 6, a first nanometer grating 330 and a second nanometer grating 340 with different grating periods are arranged in a first modulating region 310 and a second modulating region 320 respectively. It may achieve varying degrees of phase angle modulation on the light wave phase information of the light passing through the first modulating region 310 and the second modulating region 320. The optical layer thickness phase control plate means that the respective modulating regions in the phase control plate 300 are provided with thin film stack layers with different thicknesses therein, to achieve varying degrees of phase angle modulation on the light wave phase information of the light passing through the modulating regions. In the example of the phase control plate 300 shown in FIG. 7, the film layers arranged in the first modulating region 310 have a different thickness from those arranged in the second modulating region 320. It may also achieve varying degrees of phase angle modulation on the light wave phase information of the light passing through the first modulating region 310 and the second modulating region 320. The liquid crystal phase control plate means that the respective modulating regions in the phase control plate 300 are provided with independently controllable liquid crystal cells therein, to achieve varying degrees of phase angle modulation on the light wave phase information of the light passing through the modulating regions by controlling rotation angles of liquid crystal molecules in the liquid crystal cell. In the example of the phase control plate 300 shown in FIG. 8, the liquid crystal cells 350 are arranged in the modulating regions such as the first modulating region 310 and the second modulating region 320. It may also achieve varying degrees of phase angle modulation on the light wave phase information of the light passing through the respective modulating regions by controlling rotation angles of liquid crystal molecules in the liquid crystal cell (for example, by controlling voltage applied onto liquid crystal molecule layers in the liquid crystal cells).

In FIG. 6 to FIG. 8, in order to show the phase control plate 300 more clearly, the optical switch 200 is not shown. They are only given by way of examples.

Based on the same concept, an embodiment of the present disclosure also provides a display method for a holographic display apparatus. The principle of solving the problem by the display method is similar to the principle of solving the problem by the holographic display apparatus, thus, the embodiments of the display method may refer to those of the holographic display apparatus. The details will be omitted herein.

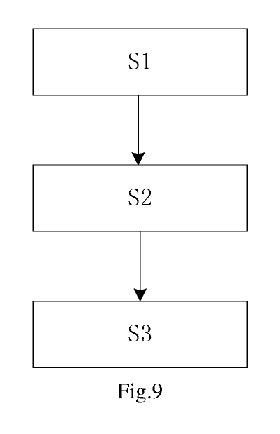

In particular, as shown in FIG. 9, the holographic display method provided by the embodiment of the present disclosure includes the following steps:

S1: supplying a coherent reference light by a backlight source;

S2: modulating light wave phase information of the coherent reference light by the phase control plate; and

S3: modulating light wave amplitude information of the coherent reference light by the optical switch depending on received modulation signals to achieve dynamic holographic display.

In an embodiment, a signal source may separate the amplitude information from the phase information from each other depending on holographic image information which needs to be displayed, then the modulation information is loaded into the modulation signal and to be transmitted to the optical switch for regulation while the phase control plate may be regulated depending on the phase information or the light wave phase information may be modulated by using a constant modulation phase control plate; after the light wave amplitude information is modulated by the optical switch while the light wave phase information is modulated by the phase control plate, the holographic image may be restored.

The above holographic display apparatus and the display method thereof provided by the embodiment of the present disclosure, includes: a backlight source configured to supply a coherent reference light; an optical switch configured to modulate light wave amplitude information of the coherent reference light; and a phase control plate configured to modulate light wave phase information of the coherent reference light; wherein the phase control plate and the optical switch are arranged on a light exit side of the backlight source. The phase modulation and the amplitude modulation are arranged separately to achieve independent control of light wave phase information and light wave amplitude information, thus, use of the optical switch to modulate the light wave amplitude information and use of the phase control plate to modulate the light wave phase information may facilitate to improve capability of controlling the modulated objects to achieve holographic display with high quality. And the light wave phase information may be modulated by the phase control plate. It may achieve naked eyes' three dimensional display in multi-views.

Apparently, the skilled person in the art can make various modifications and variations on the present disclosure without departing spirit and scope of the present disclosure. In this way, the present disclosure is also intended to cover these modifications and variations if these modifications and variations fall within claims and equivalents thereof of the present disclosure.

1. A holographic display apparatus, comprising:
a backlight source configured to supply a coherent reference light;
an optical switch configured to modulate light wave amplitude information of the coherent reference light; and
a phase control plate configured to modulate light wave phase information of the coherent reference light,
wherein the phase control plate and the optical switch are arranged on a light exit side of the backlight source.

2. The holographic display apparatus according to claim 1, wherein the phase control plate is arranged between the backlight source and the optical switch.

3. The holographic display apparatus according to claim 1, wherein
the phase control plate comprises a plurality of modulating regions independent from each other; and
the modulating regions are in one-to-one correspondence with the pixel regions in the optical switch.

4. The holographic display apparatus according to claim 3, wherein two adjacent modulating regions modulate the coherent reference light at different phase modulation angles.

5. The holographic display apparatus according to claim 4, wherein all of the modulating regions modulate the coherent reference light at a constant phase modulation angle.

6. The holographic display apparatus according to claim 4, wherein all of the modulating regions modulate the coherent reference light at a phase modulation angle which is variable depending on received amplitude modulation signals.

7. The holographic display apparatus according to claim 4, wherein the phase control plate comprises a grating phase control plate, an optical layer thickness phase control plate, or a liquid crystal phase control plate.

8. The holographic display apparatus according to claim 1, wherein the optical switch comprises a liquid crystal display device, an electrochromic device or a photochromic device.

9. The holographic display apparatus according to claim 1, wherein the coherent reference light supplied by the backlight source is a coherent collimated light.

10. A display method for the holographic display apparatus according to claim 1, the method comprising:
supplying the coherent reference light by the backlight source;
modulating light wave phase information of the coherent reference light by the phase control plate; and
modulating light wave amplitude information of the coherent reference light by the optical switch depending on a received modulation signal.

11. The holographic display apparatus according to claim 1, wherein the phase control plate is arranged on a light exit side of the optical switch.

12. The holographic display apparatus according to claim 1, wherein the phase control plate comprises a plurality of modulating regions independent from each other, and one of the modulating regions corresponds to a plurality of pixel regions in the optical switch.

13. The holographic display apparatus according to claim 12, wherein two adjacent modulating regions modulate the coherent reference light at different phase modulation angles.

14. The holographic display apparatus according to claim 13, wherein all of the modulating regions modulate the coherent reference light at a constant phase modulation angle.

15. The holographic display apparatus according to claim 13, wherein all of the modulating regions modulate the coherent reference light at a phase modulation angle which is variable depending on received amplitude modulation signals.

16. The holographic display apparatus according to claim 13, wherein the phase control plate comprises a grating phase control plate, an optical layer thickness phase control plate, or a liquid crystal phase control plate.

17. The holographic display apparatus according to claim 4, wherein the phase modulation angles are selected in a range between 0 and 2π.

18. The holographic display apparatus according to claim 13, wherein the phase modulation angles are selected in a range between 0 and 2π.

19. The holographic display apparatus according to claim 2, wherein the coherent reference light supplied by the backlight source is a coherent collimated light.

20. The holographic display apparatus according to claim 3, wherein the coherent reference light supplied by the backlight source is a coherent collimated light.
